(19) United States
(12) Patent Application Publication
(10) Pub. No.: US 2006/0285909 A1
(43) Pub. Date: Dec. 21, 2006

(54) Pinch plate lifting in a printer

(76) Inventors: Choon-Siang Peck, Singapore (SG); Xiaoxi Huang, Singapore (SG); Ngan-Pin Alex Goh, Singapore (SG)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/156,325

(22) Filed: Jun. 16, 2005

(51) Int. Cl. B41J 13/03

(52) U.S. Cl. 400/636.3

(57) ABSTRACT

A pinch plate lifting apparatus in a printer for lifting a pinch plate from a linefeed roller is provided. The pinch plate lifting apparatus includes a camshaft rotatably mounted in the printer and at least one cam attached to the camshaft. The cam has a predefined profile and is able to rotate together with the camshaft. The predefined profile of the cam abuts the pinch plate such that the lifting of the pinch plate from the linefeed roller is controllable by the rotation of the camshaft.

### FIELD OF THE INVENTION

The invention relates generally to printers, and more particularly to a pinch plate lifting apparatus in a printer.

### BACKGROUND OF THE INVENTION

A printer generally uses a linefeed roller and an output roller to drive a medium in the printer during a printing operation. The linefeed roller and the output roller are driven by a servo motor. The printer also includes pinch rollers and star wheels. A pick motor controls a pick system to pick up the medium, for example a paper, from an input tray and feeds it to the linefeed roller. The linefeed roller drives the paper into a printing zone where droplets of ink are sprayed onto the paper from an ink cartridge.

One or more pinch rollers are biased against the linefeed roller so that the paper is driven between the pinch rollers and the linefeed roller. Since the pinch rollers are biased against the linefeed roller, a pinch force is exerted on the paper.

The linefeed roller and the pinch rollers control the advancement of the paper during most of the printing process. Once the bottom of form (BOF) edge of the paper leaves the linefeed roller and the pinch rollers (the pinching point), the output roller drags the paper from the printing area to an output tray. One or more star wheels are normally used together with the output roller to drag the paper from the printing area. The star wheels are located adjacent to the output roller, with the spikes of the star wheels touching the output roller. The paper is dragged out of the printing area between star wheels and the output roller.

The configuration of the printer described above allows the printer to continue to print on the paper even when the paper has left the pinching point. This enables the printed image on the paper to have very small BOF margin, or even full bleed printing.

However, the configuration of the printer described above makes small BOF margin or full bleed duplex printing difficult. During small BOF margin or full bleed printing, the paper leaves the pinching point. Since the pinch rollers are biased against the linefeed roller, it is difficult to reverse the paper through the pinch rollers and the linefeed roller into a duplexer unit if duplex printing is desired.

Furthermore, after small BOF margin or full bleed printing, the paper at the BOF region normally becomes cockled. If the paper is to reverse through the pinch rollers and the linefeed roller into the duplexer unit, it is likely to cause paper jam or even damage to the printer mechanisms.

As a result, the duplexer unit is normally located at the front of the printer, that is, on the same side of the input tray. Therefore, the paper need not reverse through the pinch rollers and the linefeed roller to the duplexer unit. However, such a design of the printer causes the size of the printer to be large and inconvenient to use.

### SUMMARY OF THE INVENTION

In an embodiment, a pinch plate lifting apparatus in a printer for lifting a pinch plate from a linefeed roller is provided. The pinch plate lifting apparatus includes a camshaft rotatably mounted in the printer and at least one cam attached to the camshaft. The cam has a predefined profile and is able to rotate together with the camshaft. The predefined profile of the cam abuts the pinch plate such that the lifting of the pinch plate from the linefeed roller is controllable by the rotation of the camshaft.

### BRIEF DESCRIPTION OF THE DRAWINGS

The embodiments of the invention will be better understood in view of the following drawings and the detailed description.

FIG. 1 shows a cross-sectional view of a part of a paper driving mechanism in a printer.

FIG. 2 shows an isometric view of a pinch plate lifting apparatus with a pinch support holder and a transmission gear train according to an embodiment.

FIG. 3 shows the cross-sectional view of the transmission gear train with a selector gear disengaged from a connecting gear according to an embodiment.

FIG. 4 shows the cross-sectional view of the transmission gear train with the selector gear engaged with the connecting gear according to an embodiment.

FIG. 5 shows a cross-sectional view of a pick motor and its relation with an idler gear of the transmission gear train according to an embodiment.

FIG. 6a shows a cross-sectional view of the pinch plate lifting apparatus with a cam in a home position according to an embodiment.

FIG. 6b shows the cross-sectional view of the pinch plate lifting apparatus with the cam in a position pushing the pinch plate, resulting in the pinch plate to be lifted away from the linefeed roller according to an embodiment.

FIG. 7 shows a cross-sectional view of a protrusion of the pinch support holder and a protrusion of the pinch plate acting as stoppers for the cam according to an embodiment.

FIG. 8 shows a flow chart of a process for duplex printing according to an embodiment.

### DETAILED DESCRIPTION OF THE INVENTION

FIG. 1 shows a cross-sectional view of a part of a paper driving mechanism in a printer according to an embodiment. The paper driving mechanism includes a linefeed roller 101, an output roller 102, a servo motor 103, a pinch roller 104 and a star wheel 105. The servo motor 103 drives the linefeed roller 101 and the output roller 102. The pinch roller 104 is mounted at one end of a pinch plate 106. The other end of pinch plate 106 is attached to a spring 107. The pinch plate 106 is pivoted 108 between the two ends. The pinch roller 104 is biased by the spring 107 to the linefeed roller 101.

Although only one pinch plate 106 is shown, and one spring 107 is attached to a first end of the pinch plate 106, it should be noted that it is possible that the paper driving mechanism includes more than one pinch plates 106 with one or more springs 107 attached to each pinch plate 106 in other embodiments. Also, each pinch plate 106 may include one or more mounted pinch rollers 104. Similarly, the paper driving mechanism may also include more than one star wheels 105 in other embodiments.

The spring 107 is attached to the pinch plate 106 at one end, and to a pinch support holder 109 at the other end. A camshaft 110 is mounted at the pinch support holder 109, and can be rotated with respect to it. A cam 120 is attached to the camshaft 110. The cam is rotatable together with the camshaft 110, and has a predefined profile (not shown in FIG. 1) which abuts the pinch plate 106. The structure of the pinch support holder 109, the cam 120 and the camshaft 110 will be described in greater detail later.

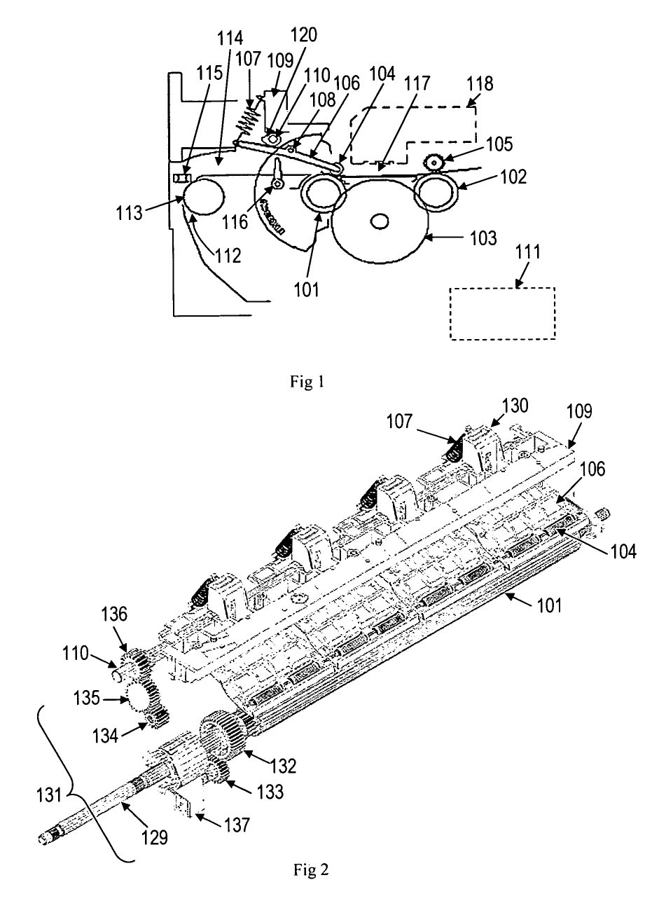

FIG. 2 shows an isometric view of the pinch plate lifting apparatus with a transmission gear train 131 according to an embodiment. It can be seen that the pinch plate lifting apparatus includes four springs 107 and four pinch plates 106. Each spring 107 is attached to a protruding mounting member 130 of the pinch support holder 109. It should however be noted that the pinch plate lifting apparatus may include any number of springs 107 and pinch plates 106 in other embodiments. The camshaft 110 is supported by the pinch support holder 109, and is rotatable with respect to the pinch support holder 109. In an embodiment, the pinch plate 106 is also pivoted 108 at the pinch support holder 130.

The transmission gear train 131 includes an idler gear 132 rotatably mounted on a same shaft 129 of the linefeed roller 101, a selector gear 133, two connecting gears 134, 135 and a camshaft gear 136. The idler gear 132 is able to rotate independently from the shaft 129 of the linefeed roller 101. The selector gear 133 is engaged to the idler gear 132, and can be selected using a selector mechanism 137 to be engaged with the connecting gear 134 or with another system such as the pick system.

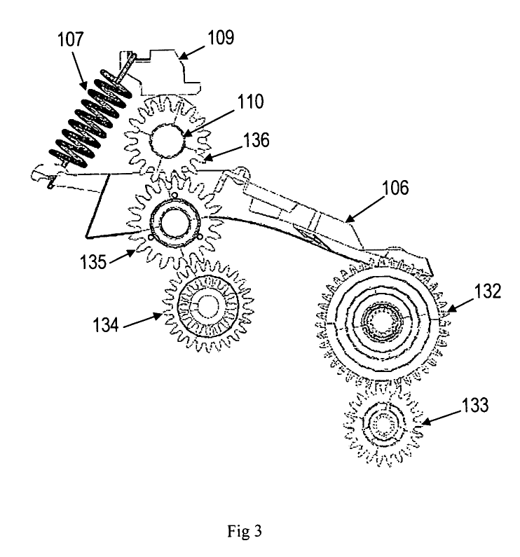

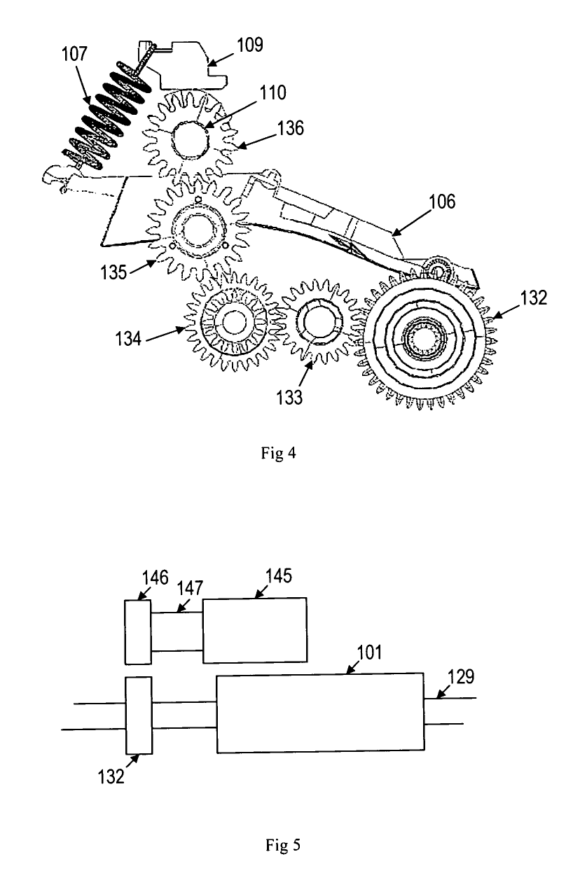

FIG. 3 shows the transmission gear train 131 with the selector gear 133 disengaged from the connecting gear 134. FIG. 4 shows the transmission gear train 131 with the selector gear 133 engaged with the connecting gear 134.

The transmission gear train 131 transfers a torque or rotation from a pick motor to the camshaft 110. FIG. 5 shows a cross-sectional view of the pick motor 145 and its relation with the idler gear 132 in an embodiment. The pick motor 145 drives a pick motor gear 146 using a rotating shaft 147. The pick motor gear 146 is engaged with the idler gear 132. The rotation of the pick motor gear 146 causes the idler gear 132 to rotate. It can be seen that a clockwise rotation of the pick motor gear 146 by the pick motor 145 results in the counter-clockwise rotation of the camshaft 110. Similarly, a counter-clockwise rotation of the pick motor gear 146 results in the clockwise rotation of the camshaft 110. The transmission gear train 131 has a reduction ratio of 18.9 in one embodiment.

It should be noted that it is also possible to use a separate motor in another embodiment for directly rotating the camshaft 110. In this embodiment, the rotation of the camshaft 110 is not controlled by the pick motor 145. Therefore, the transmission gear train 131 for connecting the pick motor 145 to the camshaft 110 is not needed.

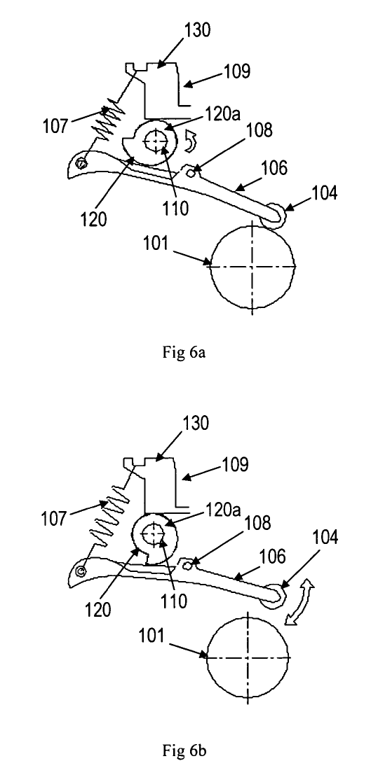

FIG. 6a shows a cross-sectional view of the pinch plate lifting apparatus according to an embodiment. The cam 120 provided on the camshaft 110 has a predefined profile 120a. The profile 120a of the cam 120 abuts or contacts the pinch plate 106, at a portion between the first end and the pivot 108. The profile 120a of the cam 120 is defined in such a manner that a rotation of the camshaft 110 in a counter-clockwise direction (as seen from FIG. 6a) pushes the first end of the pinch plate 106 away from the camshaft 110. The pushing of the first end of the pinch plate 106 by the cam 120 causes the distance between the pinch plate 106 and the camshaft 110 to increase as shown in FIG. 6b. As a result, the pinch plate 106 is rotated about its pivoted point 108, causing the second end of the pinch plate 106 where the pinch rollers 104 are mounted on to be lifted from the linefeed roller 101.

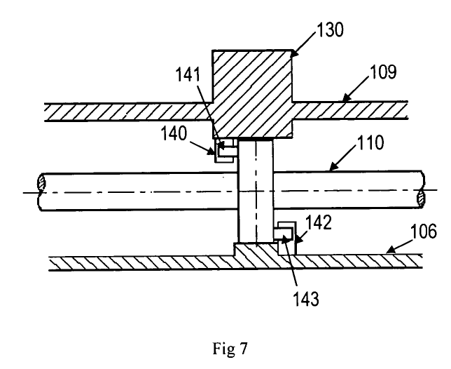

The pinch support holder 109 may include a protrusion 140 for the cam 120 as shown in FIG. 7. The cam 120 also includes a corresponding protrusion 141. When the camshaft 110 is rotated in the clockwise direction beyond a certain point, the protrusion 141 of the cam 120 is restrained by the protrusion 140 of the pinch support holder 109. Therefore, any further clockwise rotation of the camshaft 110 is prevented.

Accordingly, the protrusion 140 of the pinch support holder 130 acts as a stopper for the cam 120 and prevents the rotation of the camshaft 110 in the clockwise direction beyond an end point. Therefore the protrusion 140 may be used as a hard stop for firmware identification and counts reset for the rotation of the camshaft 110 in the clockwise direction. This hard stop is also referred as a home position of the camshaft 110.

A second hard stop may be provided as an end point for the rotation of the camshaft 110 in the counter-clockwise direction. The second hard stop may be provided as a protrusion 142 extending from the pinch plate 106 as shown in FIG. 7 in one embodiment. In this embodiment, the cam 120 includes a second corresponding protrusion 143. When the camshaft 110 is rotated in the counter-clockwise direction beyond an end point, the second corresponding protrusion 143 of the cam 120 is restrained by the protrusion 142 of the pinch plate 106. Therefore, any further counter-clockwise rotation of the camshaft 110 is prevented. The second hard stop may also be controlled by motor stall torque values using firmware in another embodiment.

When a print job is initiated, a medium, such as a paper, is picked from an input tray 111 by the pick motor 145 (see FIG. 1). The medium travels along a path indicated by the arrow 112 and is driven by a turn roller 113 into a paper guiding zone 114. A paper sensor 115 senses the presence of the medium in the guiding zone 114 and an Out Of Paper Sensor (OOPS) 116 senses the Bottom of Form (BOF) edge (or trailing edge) of the medium.

During a printing process, the medium in the guiding zone 114 is driven into a printing zone 117 by the linefeed roller 101 and the pinch rollers 104. In the printing zone 117, droplets of ink are ejected from an ink cartridge 118 onto the medium. Once the BOF edge of the medium has left the pinching point, the output roller 102 and the star wheels 105 drive the medium from the printing zone 117 into an output tray (not shown).

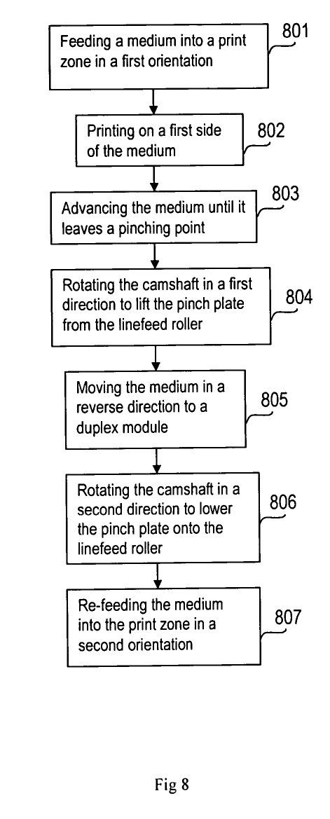

FIG. 8 shows a flow chart of a printing process for duplex printing according to an embodiment. When the printer receives a print job for duplex printing, the printer may first switch the selector mechanism 137 to engage the selector gear 133 to the connecting gear 134 in one embodiment. In another embodiment, the selector mechanism 137 may be switched to engage the selector gear 133 to the connecting gear 134 when a paper is detected by the paper sensor 115. After the connecting gear 134 is engaged by the selector gear 133, the pick motor 145 is usually rotated in the counter-clockwise direction until the corresponding protrusion 141 of the cam 120 touches the protrusion 140 of the pinch support holder 109. This ensures that the camshaft 110 is in its home position.

Step 801 includes feeding the medium into the printing zone 117 in a first orientation suitable for printing on a first side of the medium. The medium is normally fed or advanced into the printing zone 117 in a series of paper advancement steps by the linefeed roller 101 and the pinch plate rollers 104.

Step 802 includes printing on the first side of the medium. Step 803 includes advancing the medium in a forward direction until the BOF or trailing edge of the medium leaves the pinching point defined between the pinch plate 106 and the linefeed roller 101. The point when the trailing edge of the medium leaves the pinching point can be detected by the OOPS 116. Specifically, after the OOPS has detected the trailing edge of the medium, the point when the trailing edge leaves the pinching point is determined as the point when the paper advancement has exceeded a predetermined number of steps.

Step 804 includes rotating the camshaft 110 in a first direction to lift the pinch plate 106 from the linefeed roller 101. Specifically, the pick motor 145 is rotated in the clockwise direction, which translates to a counter-clockwise rotation (first direction) of the camshaft 110. When the pinch plate 106 is lifted from the linefeed roller 101, a gap is defined between them. In an embodiment, the camshaft 110 is rotated in the first direction until the second corresponding protrusion 143 of the cam 120 touches the protrusion 142 of the pinch plate 106.

Step 805 includes moving the medium in a reverse direction through the gap to a duplex module to change the orientation of the medium from the first orientation to a second orientation suitable for printing on a second side of the paper. The paper is moved in the reversed direction by the output roller 102 and the star wheels 105.

Step 806 includes rotating the camshaft 110 in a second direction to lower the pinch plate 106 onto the linefeed roller 101 once the BOF of the medium is detected by the OOPS 116. Similarly, the pick motor 145 is rotated in the counter-clockwise direction, which translates to a clockwise rotation (second direction) of the camshaft 110. In an embodiment, the camshaft 110 is rotated in the second direction until the corresponding protrusion 141 of the cam 120 touches the protrusion 140 of the pinch support plate 109, that is, at the home position.

Step 807 includes re-feeding the medium into the printing zone 117 for printing on the second side of the medium. After printing on the second side of the medium is completed, the paper is ejected from the printer by the output roller 102. The printer may then switch the selector mechanism 137 to disengage the selector gear 133 from the connecting gear 134 in one embodiment. This allows the pick motor 145 to pick another medium from the input tray 117 for printing. Before disengaging the selector gear 133 from the connecting gear 134, the camshaft 110 may be rotated in the second direction to ensure that the camshaft 110 is reset to the home position.

The lifting of the pinch plate 106, and hence the pinch rollers 104, from the linefeed roller 101 allows the medium to be reversed into the guiding zone 114 even when the medium has left the pinching point. This allows small margin or even borderless duplex printing even when a duplexer is arranged at a rear end of the printer. The lifting of pinch plate 106 may also allow a thick medium, such as a CD, to be fed into the paper guiding zone 114 from the front end of the printer (the same end where the input and output tray are) for printing.

Although the present invention has been described in accordance with the embodiments as shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A pinch plate lifting apparatus in a printer for lifting a pinch plate from a linefeed roller, the pinch plate lifting apparatus comprises:
a camshaft rotatably mounted in the printer; and
at least one cam attached to the camshaft, the at least one cam has a predefined profile and is rotatable with the camshaft,
wherein the predefined profile of the at least one cam abuts the pinch plate such that the lifting of the pinch plate from the linefeed roller is controllable by the rotation of the camshaft.

2. The pinch plate lifting apparatus according to claim 1, wherein the predefined profile of the at least one cam abuts near a first end of the pinch plate.

3. The pinch plate lifting apparatus according to claim 2, wherein the pinch plate is pivoted between the first end and a second end.

4. The pinch plate lifting apparatus according to claim 3 further comprising a biasing means for biasing the first end of the pinch plate to the predefined profile of the cam, such that the second end of the pinch plate is biased to the linefeed roller.

5. The pinch plate lifting apparatus according to claim 4, wherein the predefined profile of the at least one cam is defined such that a rotation of the camshaft in a first direction pushes the first end of the pinch plate away from the camshaft, thereby lifting the second end of the pinch plate from the linefeed roller.

6. The pinch plate lifting apparatus according to claim 4, wherein the biasing means is a spring.

7. The pinch plate lifting apparatus according to claim 1 further comprising a plurality of gears which are interconnectable from a pick motor to the camshaft for transferring a torque from the pick motor to the camshaft.

8. The pinch plate lifting apparatus according to claim 7 further comprising a selector for engaging and disengaging the gears from the pick motor to the camshaft.

9. The pinch plate lifting apparatus according to claim 1 further comprising a motor for rotating the camshaft.

10. The pinch plate lifting apparatus according to claim 1 further comprising a pinch support holder wherein the camshaft is rotatably mounted thereon.

11. The pinch plate lifting apparatus according to claim 10, wherein the pinch support holder comprises at least one protrusion for preventing the camshaft from rotating beyond an end point.

12. A printer comprising:
a linefeed roller;
at least one pinch plate;
a camshaft rotatably mounted in the printer; and
at least one cam attached to the camshaft, the at least one cam has a predefined profile and is rotatable with the camshaft,
wherein the predefined profile of the at least one cam abuts near a first end of the pinch plate, such that a rotation of the camshaft causes a second end of the at least one pinch plate to be lifted from the linefeed roller.

13. The printer according to claim 12, wherein the pinch plate is pivoted between the first end and the second end.

14. The printer according to claim 13 further comprising a biasing means for biasing the first end of the pinch plate to the predefined profile of the cam, such that the second end of the pinch plate is biased to the linefeed roller.

15. The printer according to claim 14, wherein the predefined profile of the at least one cam is defined such that a rotation of the camshaft in a first direction pushes the first end of the pinch plate away from the camshaft, thereby lifting the second end of the pinch plate from the linefeed roller.

16. The printer according to claim 14, wherein the biasing means is a spring.

17. The printer according to claim 12 further comprising a plurality of gears which are interconnectable from a pick motor to the camshaft for transferring a torque from the pick motor to the camshaft.

18. The printer according to claim 17 further comprising a selector for engaging and disengaging the gears from the pick motor to the camshaft.

19. The printer according to claim 12 further comprising a motor for rotating the camshaft.

20. The printer according to claim 12 further comprising a pinch support holder wherein the camshaft is rotatably mounted thereon.

21. The printer according to claim 20, wherein the pinch support holder comprises at least one protrusion for preventing the camshaft from rotating beyond an end point.

22. A method for duplex printing comprising:
feeding a medium into a printing zone of a printer in a first orientation suitable for printing on a first side of the medium, wherein the medium is fed into the printing zone along a feeding path defined between at least one pinch plate and a linefeed roller;
printing on the first side of the medium in the printing zone;
advancing the medium in a forward direction during printing until a trailing edge of the medium leaves a pinching point between the at least one pinch plate and the linefeed roller and enters the printing zone;
rotating a camshaft in the printer in a first direction to lift the at least one pinch plate from the linefeed roller, thereby defining a gap therebetween;
moving the medium in a reverse direction through the gap to a duplex module to change the orientation of the medium from the first orientation to a second orientation suitable for printing on a second side of the medium;
rotating the camshaft in a second direction to lower the at least one pinch plate onto the linefeed roller; and
re-feeding the medium into the printing zone along the feeding path for printing on the second side,
wherein the camshaft has at least one cam attached thereto, the at least one cam has a predefined profile such that the rotation of the camshaft causes the at least one pinch plate to be lifted from the linefeed roller.

23. The method according to claim 22 further comprising sensing the trailing edge of the medium when the medium is moved in the reverse direction through the gap, wherein the camshaft is rotated in the second direction to lower the at least one pinch plate onto the linefeed roller when the trailing edge of the medium is detected.
